(19) United States
(12) Patent Application Publication
(10) Pub. No.: US 2009/0097625 A1
(43) Pub. Date: Apr. 16, 2009

(54) Method of and System for Controlling Conference Calls

(76) Inventor: Mark E. Peters, Chapel Hill, NC (US)

Correspondence Address: DILLON & YUDELL LLP, 8911 N. CAPITAL OF TEXAS HWY., SUITE 2110, AUSTIN, TX, 78759, US

(21) Appl. No.: 11/872,554

(22) Filed: Oct. 15, 2007

(51) Int. Cl. H04M 1/00; H04M 3/56

(52) U.S. Cl. 379/158; 379/162

(57) ABSTRACT

A method of and a system for controlling a conference call among a plurality of participants monitor the lines associated with the participants. When the system detects a ring on a line associated with one of the participants, the system mutes the line associated with that participant. In some embodiments, the system automatically mutes the line. In other embodiments, the system provides a mechanism by which a moderator can mute the line. In one embodiment, the detected ring may comprise an audible ring tone picked up by the telephone of the participant, as for example the participant's cell phone ringing. The system may identify the participant to the moderator and enable the moderator to mute the participant's line. The system may identify the participant by displaying identifying information for the participant on a computer display associated with the moderator. The system may display a muting control associated with the identifying information. The system may enable the moderator or the participant to unmute the line associated with the participant. In other embodiments, the detected ring may comprise a on-hold callback ring signal on participant's line. The system may automatically mute the line in response to detecting the callback ring signal. The system may monitor the muted line for an answer. Upon detecting an answer on line, the system may announce on the line that the line is muted, and provide instructions on rejoining said conference call.

### BACKGROUND OF THE INVENTION

1. Technical Field

The present invention relates generally to the field of telephone conference calling, and more particularly to a method of and system for controlling interruptions by conference call participants taking other calls.

2. Description of the Related Art

Conference calls provide a popular and convenient way in which to hold meetings. Rather than meeting in person, conference call participants attend the meeting by telephone. Conference calls allow participants to participate in meetings virtually anywhere in the world.

A common annoyance during conference calls occurs when a participant takes another call during the conference. For example, many conference call participants carry a cell phone. Often, when the cell phone rings, the participant becomes oblivious to the conference call and takes the cell phone call, thereby carrying on a side conversation that is audible to the conference. Alternatively, a participant may place the conference call line on hold and make another call. Some telephone systems may provide a ring back signal to a telephone that has been left on hold. The on hold ring back signal is audible and annoying to conference call participants.

### SUMMARY OF THE INVENTION

The present invention provides a method of and a system for controlling a conference call among a plurality of participants. The system monitors the lines associated with the participants. When the system detects a ring on a line associated with one of the participants, the system mutes the line associated with that participant. In some embodiments, the system automatically mutes the line. In other embodiments, the system provides a mechanism by which conference call moderator can mute the line.

In one embodiment, the detected ring may comprise an audible ring tone produced near the participant, as for example by a cell phone. The system may identify the participant to the moderator and enable the moderator to mute the participant's line. The system may identify the participant by displaying identifying information for the participant on a computer display associated with the moderator. The system may display a graphical muting control associated with the identifying information. The system may enable the moderator to unmute said line associated with the participant.

In other embodiments, the detected ring may comprise a callback ring signal on participant's line. The system may automatically mute the line in response to detecting the callback ring signal. The system may monitor the muted line for an answer. Upon detecting an answer on line, the system may announce on the line that the line is muted, and provide instructions on rejoining said conference call.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 illustrates an embodiment of a conference call moderator monitor window according to the present invention;

FIG. 3 is a flow chart of an embodiment of the method of the present invention;

FIG. 4 is a flow chart of an embodiment of talking processing of FIG. 3;

FIG. 5 is a flow chart of an embodiment of audible ring processing of FIG. 3; and,

FIG. 6 is a flow chart of an embodiment of callback ring processing of FIG. 3.

### DETAILED DESCRIPTION OF THE PREFERRED EMBODIMENT

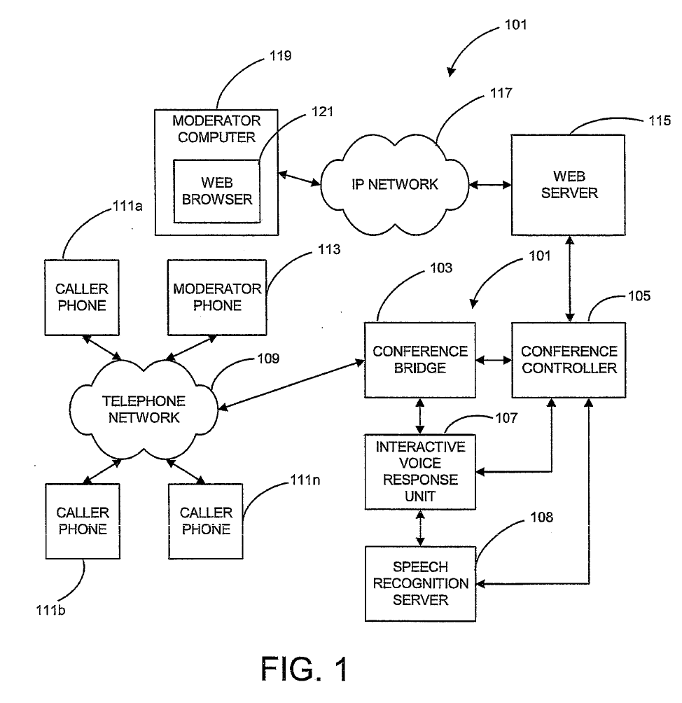

Referring now to the drawings, and first FIG. 1, a system according to the present invention is designated generally by the numeral 100. System 100 includes a conference call platform 101, which includes a conference bridge 103, a conference controller 105, an interactive voice response (IVR) unit 107, and a voice recognition server 108. Conference bridge 103 conferences together the calls comprising the conference. IVR unit 107 provides announcements and voice prompts to conference call participants. Speech recognition server 108 recognizes audible sounds and converts those sounds to computer-recognized commands and information.

Conference bridge 103 is coupled to a telephone network, indicated generally at 109. Telephone network 109 may include a public switched telephone network, an Internet telephone network, a private telephone network, or any other telephone network or combination of networks. A plurality of caller phones 111 are coupled to telephone network 109. A moderator phone 113 is also coupled to telephone network 109. As will be explained in detail hereinafter, conference call platform 101 enables callers 111 and moderator 113 to participate in conference calls according to the present invention.

System 100 may also include a web server 115 coupled to conference controller 105. Web server 115 provides web pages and web-based applications under control of conference controller 105. Web server 115 is coupled to an IP network 117. IP network 117 may comprise a local area network, a wide-area network, or any other IP network. IP network 117 is coupled to a moderator computer 119. The moderator computer 119 includes a web browser 121. A moderator computer 119 and moderator phone 113 are both accessible to a conference call moderator. Although the present embodiment of the invention is described with reference to telephone network, those skilled in the art will recognize that the invention may be applied to voice-over-Internet-protocol (VOIP) network, or a combination VOIP and telephone networks.

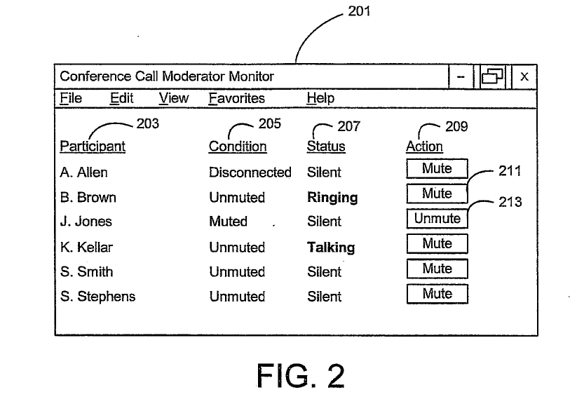

FIG. 2 illustrates an embodiment of a conference call moderator monitor window 201 according to the present invention. A conference call moderator monitor window 201 is preferably implemented as a web-based application displayed on moderator computer 119 of FIG. 1. The moderator window could also be implemented as a standalone application or as a Java™ or other type of dynamically downloadable application. Conference call moderator monitor window 201 includes a list 203 lines in the conference call and their respective condition 205 and status 207. Each line in the conference call may be identified by a participant's name. As shown in FIG. 2, condition 205 may be disconnected, muted, or unmuted. In a preferred embodiment, the default condition is unmuted. Status 207 may be silent, ringing, or talking. Ringing status indicates that a ring has been detected on the line associated with a participant. The detected ring may be an audible ring tone produced by a telephone instrument, such as a cell phone musical “ring,” in the vicinity of the participant. The detected ring may also be a ring signal, such as an on-hold callback ring, on the line of the participant. Talking status identifies a participant that is currently talking. Conference call moderator monitor window 201 includes a set 209 of graphical action buttons, which may be mute buttons 211 or unmute buttons 213. In a preferred embodiment, the default action button is mute. The moderator can actuate a mute button 211 in order to mute the line of a participant, as for example when the participant is engaged in another conversation or a phone in the vicinity of the participant is ringing. The moderator can actuate an unmute button 213 in order to unmute any muted line.

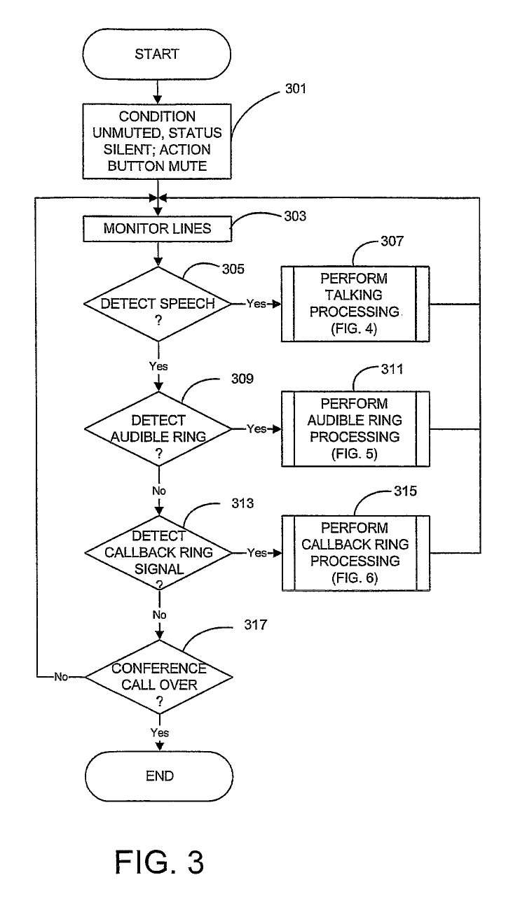

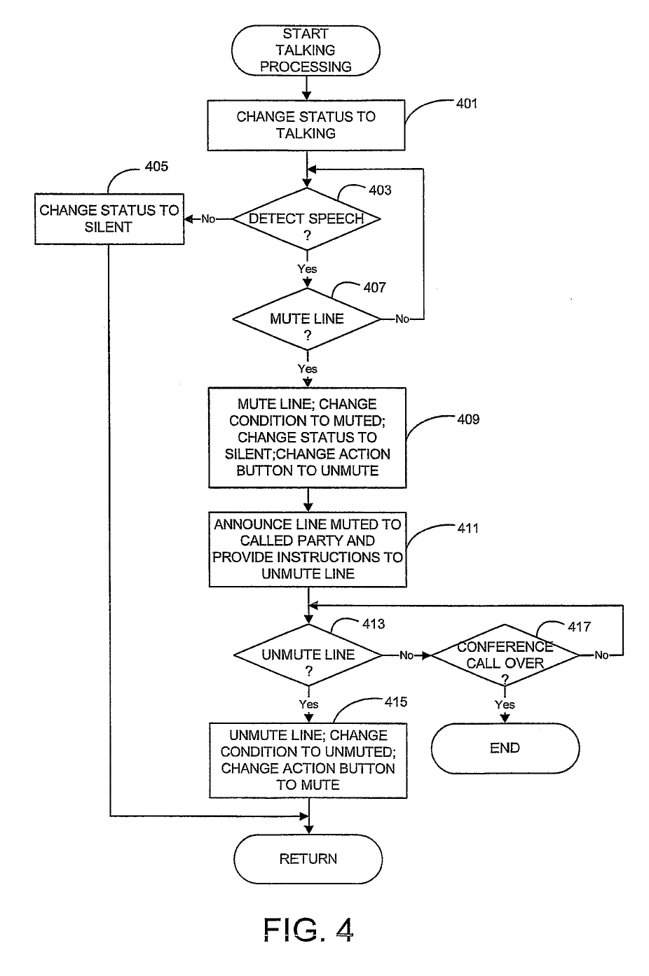

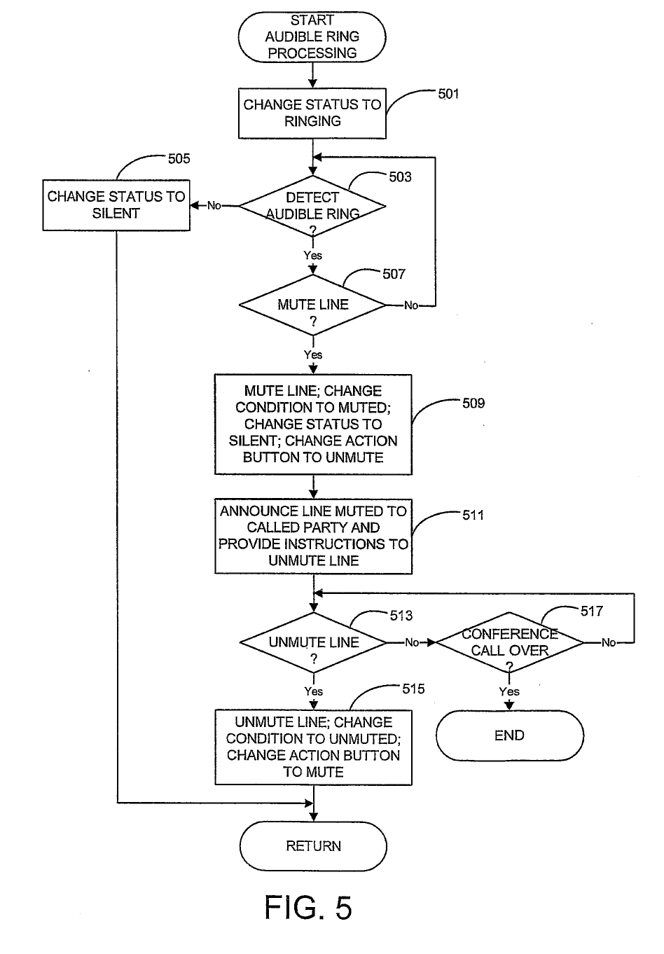

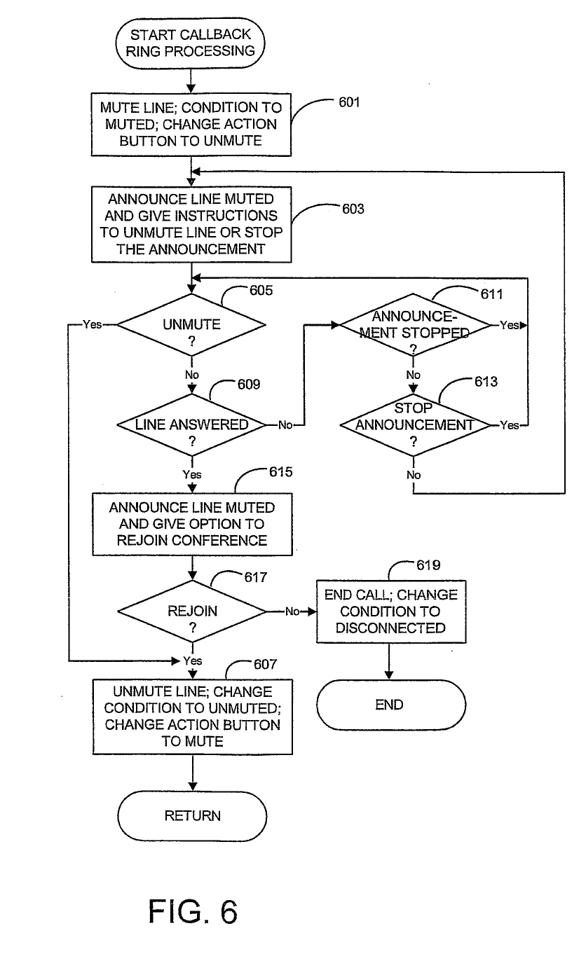

FIG. 3 is a high-level flowchart of processing according to the present invention. Initially, for each line, condition is unmuted, status is silent, and the action button is mute, as indicated at block 301. Those skilled in the art will recognize that in some embodiments, each line's condition may initially be muted. The system monitors the lines, as indicated at block 303. If, as determined at decision block 305, the system detects speech on a line, the system performs talking processing, as indicated generally at block 307 and described in detail with reference to FIG. 4. If, as determined at decision block 309, the system detects an audible ring, the system performs audible ring processing, as indicated generally at block 311 and described in detail with respect to FIG. 5. An audible ring is an ambient telephone ring that is picked up by a telephone microphone of one of the participants. The term ring is used herein in its broad sense to mean an audible signal produced by a telephone to alert a user that the telephone is being called. If, as determined at decision block 313, the system detects an on-hold callback ring signal, the system performs callback ring processing, as indicated generally at block 315 and described in detail with reference to FIG. 6. Some telephone systems produce a callback ring on a line that has been on hold for an extended period. If, as determined at decision block 311, the conference call is over, processing ends.

FIG. 4 is a flow chart of an embodiment of talking processing described briefly with reference to block 307 of FIG. 3. The system identifies the talking party to the moderator by changing the participant's line status to talking, as indicated at block 401. Alternately, the system could display the sound on a timeline graph. In the system of FIG. 1, conference call controller 105 signals Web server 115 to display talking for the participant in conference call moderator monitor window 201 of FIG. 2. If, as determined at decision block 403, the system fails to detect speech for a predetermined period of silence, the system changes the participant's status back to silent, at block 405, and processing returns to FIG. 3. The moderator may or may not mute the participant's line. If, as determined at decision block 407, the moderator actuates mute control 211 of FIG. 2, the system mutes the participant's line, changes condition to muted, changes status to silent, and changes the participant's action button to unmute, all as indicated at block 409. As indicated at block 411, the system may actuate IVR unit 107 of FIG. 1 to announce line muted and provide instructions for unmuting the line to the participant. A participant may unmute the line by entering a specified sequence of keystrokes on the telephone keypad. The moderator may unmute a muted line by actuating unmute button 209 of FIG. 2, or the participant may umute his or her line by following the instructions of block 411. If, as determined at decision block 413, the system receives an unmute signal, the system unmutes the line, changes condition back to unmuted, and changes the participant's action button back to mute, all as indicated at block 415, and processing returns to FIG. 3. If, as determined at decision block 417, the conference call ends before the moderator or the participant unmutes the participant's line, FIG. 4 processing ends.

FIG. 5 is a flow chart of an embodiment of audible ring processing described briefly with reference to block 311 of FIG. 3. The system identifies the called party to the moderator by changing the participant's status to ringing, as indicated at block 501. If, as determined at decision block 503, the system fails to detect an audible ring for a predetermined period of silence, the system changes the participant's status back to silent, at block 505, and processing returns to FIG. 3. The moderator may or may not mute the participant's line. If, as determined at decision block 507, the moderator actuates mute control 211 of FIG. 2, the system mutes the participant's line, changes condition to muted, changes status to silent, and changes the participant's action button to unmute, all as indicated at block 509. The system may also announce to the participant instructions for unmuting his or her line. As indicated at block 511, the system may actuate IVR unit 107 of FIG. 1 to make announcements to the muted participant. The moderator may unmute a muted line by actuating unmute button 209 of FIG. 2 or the participant may unmute the line by perform the actions in the announcement of block 511. If, as determined at decision block 513, the system receives an unmute signal, the system unmutes the line, changes condition back to unmuted, and changes the participant's action button back to mute, all as indicated at block 515, and processing returns to FIG. 3. If, as determined at decision block 517, the conference call ends before the moderator or the moderator unmutes the participant's line, FIG. 5 processing ends.

FIG. 6 is a flow chart of an embodiment of on-hold callback ring processing according to the present invention. The system automatically mutes the ringing line, changes condition to muted, and changes the participant's action button to unmute, all as indicated at block 601. In some embodiments, the moderator may be able to disable the automatic muting feature. The system periodically provides the participant an opportunity to rejoin the conference, by announcing that the line is muted and giving instructions to unmute the line or stop the announcement, at block 603. The participant can enter a first sequence of DTMF tones to unmute the line and a second sequence to stop the announcement. If, as determined at decision block 605, the participant unmutes the line, the system unmutes the line, changes the condition to unmuted, and changes the action button to mute, all as indicated at block 607. If the participant does not unmute the line, the system determines, at decision block 609, if the line is answered. If not, the system determines, at decision block 611, if the announcement has been previously stopped. If so, processing returns to decision block 605. If the announcement has not been previously stopped, the system determines, at decision block 613, if the participant has entered the sequence to stop the announcement. If not, processing returns to block 603; if so, processing returns to decision block 605. If, as determined at decision block 609, the line is answered, the system announces that the line is muted and gives the answering party the option to rejoin the conference, as indicated at block 615. If, as determined at block 617, the answering party elects to rejoin the conference, processing proceeds to block 607. If not, the system ends the call and changes the participant's condition to disconnected, as indicated at block 619.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

What is claimed is:

1. A method of controlling a conference call among a plurality of call-in lines, which comprises:
monitoring said call-in lines;
detecting a ring on one of said call-in lines; and,
muting said one of said call-in lines.

2. The method as claimed in claim 1, wherein said ring comprises an audible ring tone detected by a telephone instrument associated with a call-in line.

3. The method as claimed in claim 2, wherein said conference call includes a moderator and said muting step includes:
identifying said one of said call-in lines to said moderator; and,
enabling said moderator to mute said one of said call-in lines.

4. The method as claimed in claim 3, wherein:
said identifying step includes displaying identifying information for said one of said call-in lines; and
said enabling step includes providing a muting control associated with said identifying information.

5. The method as claimed in claim 3, further comprising:
enabling said moderator to unmute said one of said call-in lines.

6. The method as claimed in claim 3, wherein said enabling said moderator to unmute said one of said call-in lines comprises:
displaying identifying information for said one of said call-in lines; and,
providing an unmuting control associated with said identifying information.

7. The method as claimed in claim 1, wherein said ring comprises an on-hold callback ring signal on said one of said call-in lines.

8. The method as claimed in claim 7, wherein said muting step comprises:
automatically muting said one of said call-in lines.

9. The method as claimed in claim 7, further comprising:
periodically making an announcement on said one of said call-in lines that said one of said call-in lines is muted and giving instructions for stopping said announcement.

10. The method as claimed in claim 8, further comprising:
monitoring said one of said call-in lines for an answer.

11. The method as claimed in claim 10, further comprising:
detecting an answer on said one of said call-in lines;
announcing on said one of said call-in lines that said one of said call-in lines is muted; and,
providing instructions on rejoining said conference call.

12. The method as claimed in claim 1, further comprising:
notifying said moderator which participant is currently talking.

13. A conference call system, which comprises:
a plurality of call-in lines;
means for monitoring each said call-in line;
means for detecting a ring on one of said call-in lines; and,
means for muting said one of said call-in lines.

14. The system as claimed in claim 13, wherein said ring comprises an audible ring tone detected by a telephone instrument coupled to said one of said call-in lines.

15. The system as claimed in claim 14, further comprising:
means for identifying said one of call-in lines to a conference call moderator; and,
means for enabling said moderator to mute said one of said call-in lines.

16. The system as claimed in claim 13, wherein said ring comprises a callback ring signal on said one of said call-in lines.

17. The system as claimed in claim 16, wherein said muting means comprises:
means for automatically muting said one of said call-in lines in response to detecting said callback ring signal.

18. The system, as claimed in claim 17, further comprising:
monitoring said one of said call-in lines for an answer.

19. The system as claimed in claim 18, further comprising:
means for detecting an answer on said one of said call-in lines;
means for announcing on said one of said call-in lines that said one of said call-in lines is muted; and,
means for providing instructions on rejoining said conference call.

20. The system as claimed in claim 17, further comprising:
means for making periodic announcements that said one of said lines is muted and providing instructions on stopping said periodic announcements.
